(19) United States
(12) Patent Application Publication
(10) Pub. No.: US 2026/0148896 A1
(43) Pub. Date: May 28, 2026

(54) MULTILAYER CERAMIC ELECTRONIC DEVICE

(71) Applicant: TAIYO YUDEN CO., LTD., Tokyo (JP)

(72) Inventor: Mika NISHIZAWA, Takasaki-shi (JP)

(21) Appl. No.: 19/379,386

(22) Filed: Nov. 4, 2025

(30) Foreign Application Priority Data
Nov. 22, 2024 (JP) 2024-204067

(51) Int. Cl. H01G 4/12; H01G 4/30

(52) U.S. Cl. CPC H01G 4/1209; H01G 4/30

(57) ABSTRACT

A multilayer ceramic electronic device includes a dielectric layer including a main phase and a segregated material containing a first rare earth element, a second rare earth element and magnesium, a plurality of internal electrode layers sandwiching the dielectric layer, and external electrodes electrically connected to the plurality of internal electrode layers respectively.

### CROSS-REFERENCE TO RELATED APPLICATION

This application is based upon and claims the benefit of priority of the prior Japanese Patent Application No. 2024-204067, filed on Nov. 22, 2024, the entire contents of which are incorporated herein by reference.

### FIELD

A certain aspect of the present disclosure relates to a multilayer ceramic electronic device.

### BACKGROUND

In high-frequency communication systems, such as mobile phones, multilayer ceramic capacitors (MLCCs) have been used to eliminate noise (for example, see Japanese Patent Application Publication No. 2022-181537, Japanese Patent Application Publication No. 2015-182951, and Japanese Patent Application Publication No. 2012-033556).

### SUMMARY OF THE INVENTION

According to an aspect of the embodiments, there is provided a multilayer ceramic electronic device including: a dielectric layer including a main phase and a segregated material containing a first rare earth element, a second rare earth element and magnesium; a plurality of internal electrode layers sandwiching the dielectric layer; and external electrodes electrically connected to the plurality of internal electrode layers respectively.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B are enlarged views of XZ cross sections;

FIG. 5 illustrates a cross sectional view of a dielectric layer;

FIG. 6 illustrates a cross sectional view of a dielectric layer and an internal electrode layer;

FIG. 7 illustrates a cross sectional view of a dielectric layer and an internal electrode layer;

FIG. 8 illustrates a cross sectional view of a dielectric layer and an internal electrode layer;

FIG. 9 illustrates a flow of a manufacturing method of a multilayer ceramic capacitor;

FIG. 10A and FIG. 10B illustrate a forming process of an internal electrode; and

FIG. 11 illustrates a crimping process.

### DETAILED DESCRIPTION

The dielectric layer and the internal electrode layer included in the multilayer ceramic electronic device may be formed by sintering the powder material. However, delamination may occur between the dielectric layer and the internal electrode layer after firing.

Hereinafter, an exemplary embodiment will be described with reference to the accompanying drawings.

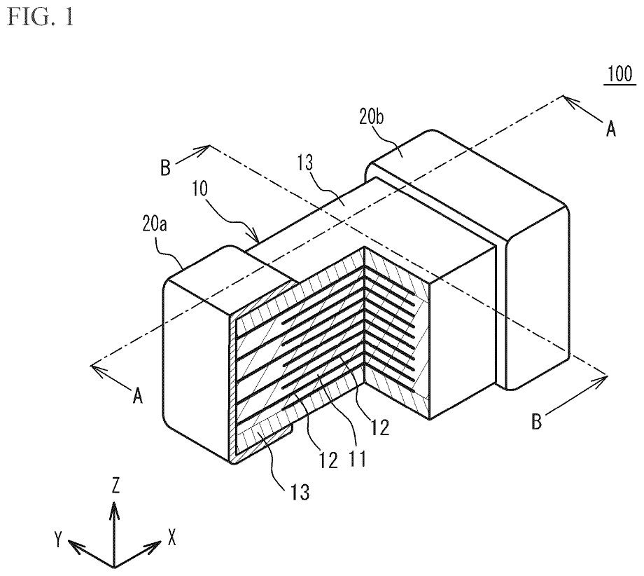

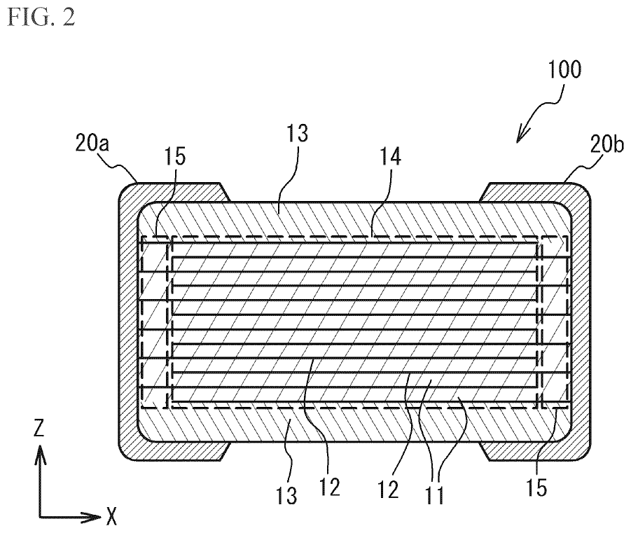

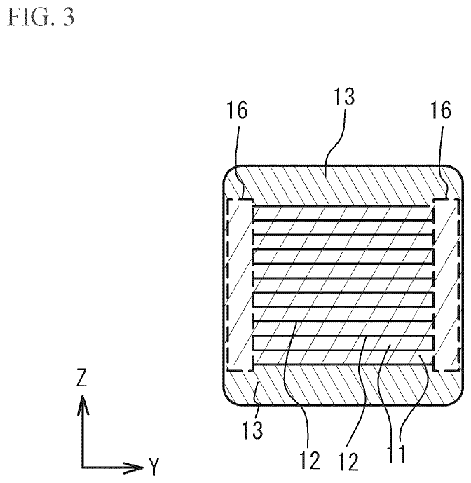

(Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes an element body 10 having a substantially rectangular parallelepiped shape, and external electrodes 20a and 20b provided on two opposing end faces of the element body 10. Among the four faces other than the two end faces of the element body 10, two faces other than an upper face and a lower face in the stacking direction are referred to as side faces. The external electrodes 20a and 20b extend to the upper face, the lower face and the two side faces of the element body 10. However, the external electrodes 20a and 20b are spaced apart from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the element body 10. The X-axis direction is a direction in which the two end faces of the element body 10 are opposite to each other and in which the external electrode 20a is opposite to the external electrode 20b. A Y-axis direction (third direction) is a width direction of the internal electrode layers. The Y-axis direction is a direction in which the two side faces of the element body 10 are opposite to each other. The X-axis direction, the Y-axis direction and the Z-axis direction are orthogonal to each other.

The element body 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first end face of the element body 10 and a second end face of the element body 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. As long as the internal electrode layer 12 is exposed to two different faces and is conductive to different external electrodes, the structure is not limited to the structure of FIG. 1 to FIG. 3.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The average thickness of each of the internal electrode layers 12 in the Z-axis direction is, for example, 1.0 μm or less, 0.5 μm or less, or 0.2 μm or less. The thickness of the internal electrode layers 12 can be measured by observing a cross section of the multilayer ceramic capacitor 100 with a scanning electron microscope (SEM), measuring the thickness at 10 points for each of the 10 different internal electrode layers 12, and deriving the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like. For example, the concentration of the main component ceramic material in the dielectric layer 11 is 90 at % or more. The thickness of the dielectric layers 11 is, for example, 1 μm or more and 11 μm or less, 1 μm or more and 10 μm or less, or 1 μm or more and 9 μm or less. The thickness of the dielectric layers 11 can be measured by observing a cross section of the multilayer ceramic capacitor 100 with a scanning electron microscope (SEM), measuring the thickness at 10 points for each of the 10 different dielectric layers 11, and deriving the average value of all the measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the element body 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

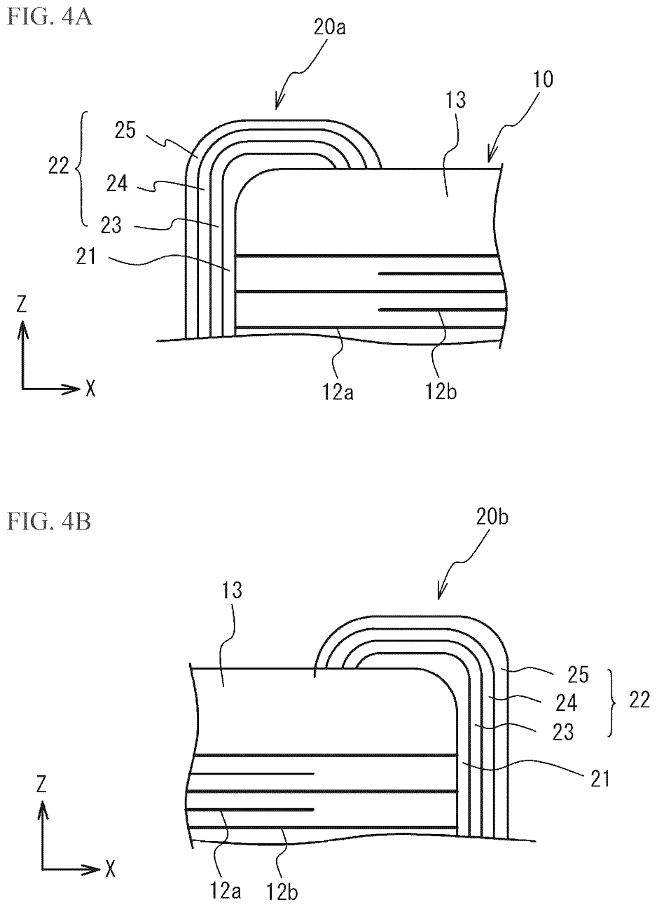

FIG. 4A is an enlarged cross-sectional view of the vicinity of the external electrode 20a. FIG. 4B is an enlarged cross-sectional view of the vicinity of the external electrode 20b. In FIG. 4A and FIG. 4B, hatches are omitted. As illustrated in FIG. 4A and FIG. 4B, the external electrodes 20a and 20b have a structure in which a plated layer 22 is formed on a base layer 21. The main component of the base layer 21 is such as nickel, copper, or the like. The base layer 21 may contain a ceramic grain as a co-material or a glass component. The plated layer 22 mainly contains metals such as Cu, Ni, aluminum (Al), zinc (Zn), and Sn, or alloys of two or more of these metals. The plated layer 22 may be a plated layer of a single metal component, or may be a plurality of plated layers of mutually different metal components. For example, the plated layer 22 has a structure in which a first plated layer 23, a second plated layer 24, and a third plated layer 25 are formed in order from the base layer 21 side. The first plated layer 23 is, for example, a Cu-plated layer. The second plated layer 24 is, for example, a Ni plated layer. The third plated layer 25 is, for example, a Sn-plated layer.

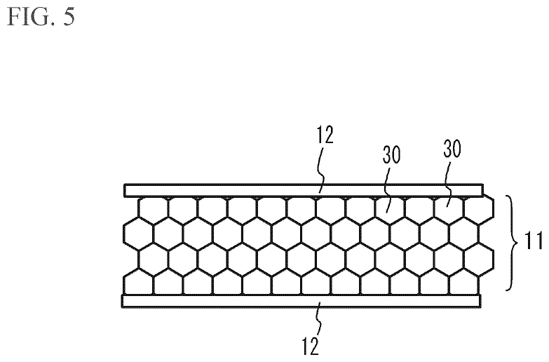

FIG. 5 is a cross-sectional view of the dielectric layer 11. As illustrated in FIG. 5, the dielectric layer 11 has a structure in which dielectric grains 30 are sintered. For example, the dielectric layer 11 may have only one of the dielectric grains 30 in the thickness direction, or may have a structure in which two or more of the dielectric grains 30 are continuous through grain boundaries as illustrated in FIG. 5. The dielectric grains 30 may be the main component ceramic of the dielectric layer 11, or may be made by solid dissolution of other elements in the main component ceramic.

In this configuration, when the powdered materials of the dielectric layer 11 and the internal electrode layer 12 are sintered during the firing process, good bonding is not achieved between the dielectric layer 11 and the internal electrode layer 12, and delamination may occur between the dielectric layer 11 and the internal electrode layer 12.

Therefore, the present inventor conducted intensive research and have found that delamination is suppressed by segregation of segregated materials containing magnesium and at least two rare earth elements (first rare earth elements and second rare earth elements) in the dielectric layer 11. This is thought to be because the contraction of the segregated material containing magnesium and containing the first rare earth element and the second rare earth element is small when sintering the powder material of the dielectric layer 11, which improves the bondability of the interface between the dielectric layer 11 and the internal electrode layer 12. Furthermore, since magnesium contained in the segregated material advances sintering, it is believed that this is because not only the vicinity of the internal electrode layer 12 of the dielectric layer 11 but also the entire dielectric layer 11 is sintered at a low temperature.

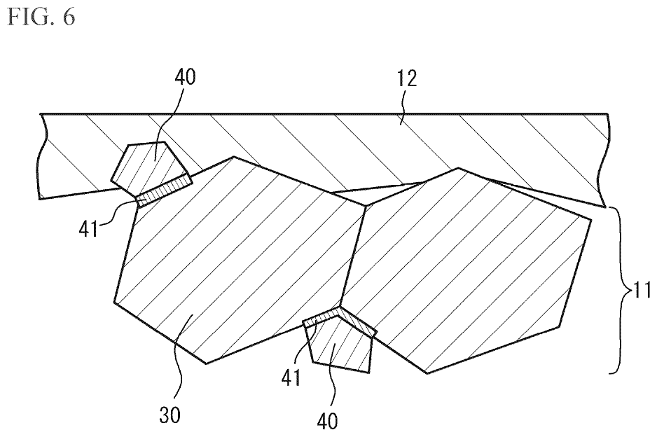

Therefore, in this embodiment, as illustrated in FIG. 6, in the dielectric layer 11, a segregated material 40 is segregated at the grain boundaries of any of the dielectric grains 30.

In the dielectric layer 11, the position of the segregated material 40 is not particularly limited, but it is preferably located at the interface between the dielectric layer 11 and the internal electrode layer 12 and in contact with the internal electrode layer 12. This is because the segregated material 40 is located at a location where delamination is likely to occur, making it easier to suppress delamination. Furthermore, pores may be formed at the interface between the dielectric layer 11 and the internal electrode layer 12. The pore is an area that does not contribute to the capacitance of the dielectric layer 11. Therefore, when the segregated material 40 is located at the interface between the dielectric layer 11 and the internal electrode layer 12, the segregated material 40 is placed at a location where pores are likely to occur, and therefore the capacitance of the dielectric layer 11 can be suppressed. Furthermore, since the segregated material 40 is an insulator, the segregated material 40 is positioned at the interface between the dielectric layer 11 and the internal electrode layer 12, thereby increasing the resistance at the interface between the dielectric layer 11 and the internal electrode layer 12, and improving reliability.

Furthermore, since magnesium has a grain growth suppression effect, the grain growth of each of the dielectric grains 30 in the dielectric layer 11 is suppressed. This suppresses the reduction in the number of grain boundaries and improves reliability. Furthermore, as illustrated in FIG. 6, part of the rare earth element contained in the segregated material 40 serves as a donor at an interface 41 between the dielectric grains 30 and the segregated material 40, thereby reducing the oxide ion vacancies at the interface between the dielectric grains 30 and the segregated material 40. This further improves reliability. Furthermore, since two or more types of rare earth elements are included, ΔS (entropy) increases at the interface 41 between the dielectric grains 30 and the segregated material 40, ΔG (Gibbs free energy) at the interface increases negatively and stabilizes, allowing rare earth elements to be present at a high concentration, further improving reliability.

For example, in the segregated material 40, the second rare earth element has an ionic radius greater than the first rare earth element. In perovskites, the larger the ionic radius, the more preferentially the solid dissolution at the A site, and the smaller the rare earth element becomes more preferred to the B site. Since the first rare earth element is desired to be selectively solid-dissolved in the B site and the second rare earth element at the A site, it is preferred to set a lower limit on the difference in the ionic radius between the first rare earth element and the second rare earth element in the segregated material 40. In this embodiment, the difference in ionic radius between the first rare earth element and the second rare earth element is preferably 0.025 Å or more, more preferably 0.030 Å or more, and even more preferably 0.035 Å or more.

On the other hand, in perovskites, the larger the ionic radius, the more preferentially the solid dissolution at the A site, and the smaller the rare earth element becomes more preferred to the B site. Since the first rare earth element is desired to be selectively solid-dissolved in the B site and the second rare earth element at the A site, it is preferred to set an upper limit on the difference in the ionic radius between the first rare earth element and the second rare earth element in the segregated material 40. In this embodiment, the difference in ionic radius between the first rare earth element and the second rare earth element is preferably 0.055 Å or less, more preferably 0.050 Å or less, and even more preferably 0.045 Å or less.

Table 1 shows the ionic radii of six coordinations of each rare earth element. The source in Table 1 is “RD Shannon, Acta Crystallogr., A32, 751 (1976).”

TABLE 1

| | | IONIC RADIUS (A) | |
|---|---|---|---|
| | VALENCE | 6-COORDINATION | 12-COORDINATION |
| Ba | 2-VALENT | | 1.610 |
| Ti | 4-VALENT | 0.605 | |
| Eu | 2-VALENT | 1.170 | |
| Dy | 2-VALENT | 1.070 | |
| La | 3-VALENT | 1.032 | |
| Tm | 2-VALENT | 1.030 | |
| Yb | 2-VALENT | 1.020 | |
| Ce | 3-VALENT | 1.010 | |
| Pr | 3-VALENT | 0.990 | |
| Nd | 3-VALENT | 0.983 | |
| Pm | 3-VALENT | 0.970 | |
| Sm | 3-VALENT | 0.958 | |
| Eu | 3-VALENT | 0.947 | |
| Gd | 3-VALENT | 0.938 | |
| Tb | 3-VALENT | 0.923 | |
| Dy | 3-VALENT | 0.912 | |
| Ho | 3-VALENT | 0.901 | |
| Y | 3-VALENT | 0.900 | |
| Er | 3-VALENT | 0.890 | |
| Tm | 3-VALENT | 0.880 | |
| Yb | 3-VALENT | 0.868 | |
| Lu | 3-VALENT | 0.861 | |
| Sc | 3-VALENT | 0.745 | |

For example, it is preferred that the first rare earth element be holmium or yttrium. The second rare earth element is preferably gadolinium or europium.

If the amount of the first rare earth element and the second rare earth element in the segregated material 40 is too small, there is a risk that the oxide ion vacancies at the interface between the dielectric grains 30 and the segregated material 40 are not sufficiently reduced. Therefore, it is preferred that the segregated material 40 has a lower limit on the amounts of the first rare earth element and the second rare earth element. On the other hand, if the amount of the first rare earth element and the second rare earth element is too large in the segregated material 40, sintering may be delayed, leaving pores behind, which may lead to deterioration in moisture resistance. Therefore, it is preferred that an upper limit be set to the amount of the first rare earth element and the second rare earth element in the segregated material 40. In this embodiment, in the segregated material 40, the molar ratio Ra/Mg of the first rare earth element to magnesium is preferably 1.5 or more and 50 or less, more preferably 3.0 or more and 40.0 or less, and even more preferably 4.0 or more and 30.0 or less. In the segregated material 40, the molar ratio Rb/Mg of the second rare earth element to magnesium is preferably 0.3 or more and 10.0 or less, more preferably 0.3 or more and 9.0 or less, and even more preferably 0.3 or more and 8.0 or less.

Since there may be a risk that the surrounding dielectric grains 30 with a large amount of the second rare earth element grow and do not satisfy the temperature characteristics, it is preferred that the amount of the first rare earth element in the segregated material 40 be the same or large as the amount of the second rare earth element. For example, in the segregated material 40, the molar ratio Ra/Rb of the first rare earth element to the second rare earth element is preferably 1.0 or more and 16.0 or less, more preferably 2.0 or more and 14.0 or less, and even more preferably 3.0 or more and 12.0 or less.

The molar ratio Ra/Mg, the molar ratio Rb/Mg, and the molar ratio Ra/Rb can be measured using the following method. In the cross section of the dielectric layer 11, first, a transmission electron image is photographed using a TEM (transmission electron microscope) at a magnification of 15,000 times, and a mapping analysis of EDS is performed to search for segregation of the first rare earth element, the second rare earth element, and magnesium. The found segregation is analyzed by point analysis and the molar ratio Ra/Mg, the molar ratio Rb/Mg, and the molar ratio Ra/Rb are measured.

If the segregated material 40 is too small in the dielectric layer 11, there is a risk of delamination, grain growth, or the like. Therefore, it is preferred to set a lower limit on the size of the segregated material 40. In this embodiment, in the cross section of the dielectric layer 11, the average grain size of the segregated material 40 is preferably 0.1 μm or more, more preferably 0.2 μm or more, and even more preferably 0.3 μm or more.

If the segregated material 40 is too large in the dielectric layer 11, there is a risk that the dielectric constant will decrease. Therefore, it is preferred to set an upper limit on the size of the segregated material 40. In this embodiment, in the cross section of the dielectric layer 11, the average grain size of the segregated material 40 is preferably 2.0 μm or less, more preferably 1.5 m or less, and even more preferably 1.0 μm or less.

The average grain size of the segregated material 40 can be measured using the following method. First, a BSE image of the cross-section of the dielectric layer 11 is photographed at 5000 times with an SEM (scanning electron microscope). Next, EDS mapping is performed at that magnification, and the area of the segregated material 40 is measured using an area measuring software. The diameter is determined, assuming the area of the segregated material 40 is a circle. The diameter determined by (diameter=2×√ (area of the segregated material 40/π)) is the diameter of the segregated material 40. The average value of the diameters of all of the segregated materials 40 is the average grain size of the segregated materials 40.

Furthermore, if the number of the segregated materials 40 in the dielectric layer 11 is too small, there is a risk that the reliability is not sufficiently improved. Therefore, it is preferred to set a lower limit to the number of the segregated materials 40 in the dielectric layer 11. In this embodiment, in the cross section of the dielectric layer 11, it is preferable that the number of the segregated material 40 is 0.01/μm² or more on average, it is more preferable that the number of the segregated material 40 is 0.01/μm² or more on average, and it is still more preferable that the number of the segregated material 40 is 0.03/μm² or more on average.

Furthermore, if the number of the segregated materials 40 in the dielectric layer 11 is too large, there is a risk that the dielectric constant will decrease. Therefore, it is preferred to set an upper limit on the number of the segregated materials 40 in the dielectric layer 11. In this embodiment, in the cross section of the dielectric layer 11, it is preferable that the number of the segregated material 40 is 1/μm² or less on average, it is more preferable that the number of the segregated material 40 is 0.5/μm² or less on average, and it is still more preferable that the number of the segregated material 40 is 0.1/μm² or less on average.

The number of the segregated materials 40 can be measured using the following method. First, a BSE image of the cross-section of the dielectric layer 11 is photographed at 5000 times with an SEM (scanning electron microscope). Next, EDS mapping is performed at that magnification to search for the segregated materials 40. The measured number of the segregated materials 40 is divided by the area of the field of view, and the obtained value is the number of the segregated materials 40.

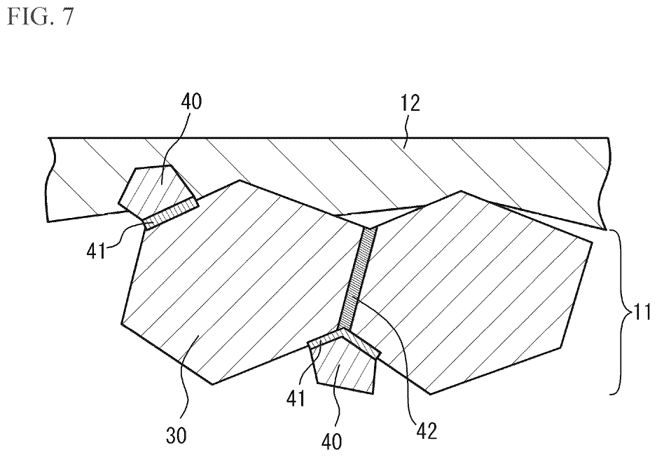

Furthermore, as illustrated in FIG. 7, the dielectric grains 30 preferably have a grain boundary phase 42 in a portion that contacts the grain boundary. The grain boundary phase 42 includes silicon, aluminum, manganese and vanadium. The grain boundary phase 42 includes silicon and aluminum, resulting in a structure in which the grain boundary phase 42 is wetted and spread. For example, a structure is obtained in which the dielectric grains 30 are coated onto the grain boundary phase 42. By containing manganese and vanadium, elements that exist at the grain boundary phase 42 and that increase lifetime, the structure is like wetting and spreading manganese and vanadium. Manganese forms a positive double Schottky electrically at the grain boundary, and electrically positive oxide ion vacancies repel charges, preventing them from jumping over the grain boundary, improving reliability. Vanadium is a donor that is likely to exist at grain boundaries, thus reducing oxide ion vacancies at grain boundaries. Therefore, the formation and movement of oxide ion vacancies at grain boundaries can be suppressed, and reliability can be improved.

The thickness of this grain boundary phase 42 is 10 nm or more and 150 nm or less, and the number of the grain boundary phases 42 in the cross section of the dielectric layer 11 is 0.01/μm² or more and 1/μm² or less on average, which increases the resistance of the grain boundary phase 42 and improves reliability.

The average number of the grain boundary phases 42 having a thickness of 10 nm or more in the cross section of the dielectric layer 11 can be measured using the following method. First, in the cross section of the dielectric layer 11, a transmission electron image is photographed and line analysis of EDS is performed using a NEOARM (transmission electron microscope) using a TEM (transmission electron microscope). A transmitted electron image is photographed at a magnification of 40,000 times, and candidates for areas with thick grain boundary phases are searched in the field of view. Next, the area where the grain boundary phase is thick is enlarged, the transmitted electron image is photographed at 100,000 times, and the line analysis of the EDS is performed. Line analysis of EDS is performed at three locations per grain boundary phase. It is confirmed that the amounts of silicon, aluminum, manganese and vanadium are greater in grain boundary phase than in the dielectric grains. In the grain boundary phases containing silicon, aluminum, manganese and vanadium, the average length of the silicon present at three points is calculated. The grain boundary phases having the average length of 10 nm or more is counted, the counted number is divided by the area of the field of view of the first photographed transmitting electron image, and the calculated value is assumed to be the average number (pcs/μm²).

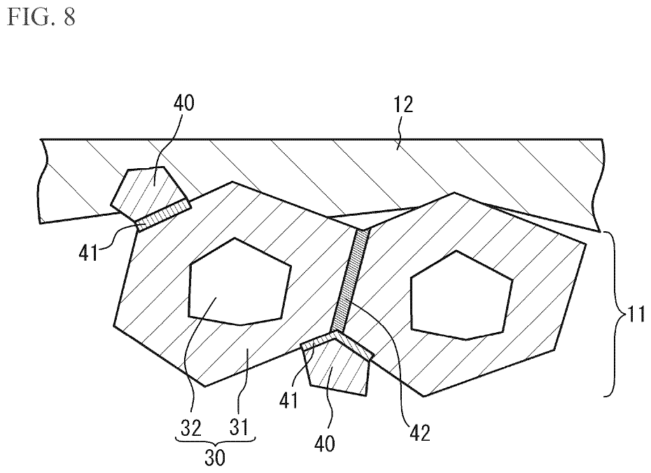

Furthermore, as illustrated in FIG. 8, at least one of the dielectric grains 30 preferably have a core-shell structure. For example, if at least a portion of the dielectric grains included in the dielectric layer 11 in the capacity section 14 has a core-shell structure, the dielectric layer 11 in the capacity section 14 has a high dielectric constant and excellent temperature characteristics, and stable microstructures coexist.

Here, an overview of dielectric grains having a core-shell structure will be explained. The dielectric grains 30 having a core shell structure include a core portion 31 having a generally spherical shape and a shell portion 32 that surrounds the core portion 31. The core portion 31 is a crystalline portion in which the added compound is not solid-dissolved or the added compound has a small amount of solid solution. The shell portion 32 is a crystalline portion in which the added compound is solid-dissolved and has a concentration of the added compound higher than the concentration of the added compound in the core portion 31. The concentration of the added compound in the shell portion 32 is higher than the concentration of the added compound in the core portion 31. Alternatively, the added compound is diffused into the shell portion 32, and the added compound is not diffused into the core portion 31.

In the dielectric layer 11, the average grain size of the dielectric grains 30 is, for example, 0.1 μm or more and 0.5 μm or less. The average grain size of the dielectric grains 30 can be measured by the following method. First, a BSE image is photographed at 15,000 times on the cross section of the dielectric layer 11 using an SEM (scanning electron microscope). Next, a straight line of about 6 μm is measured by pulling it parallel to the internal electrode layer 12 onto the dielectric layer 11, and the length is set to “a”. The dielectric grains 30 on the line are counted, and the number is “n”, and the value of a/n is the average grain size of the dielectric grains 30.

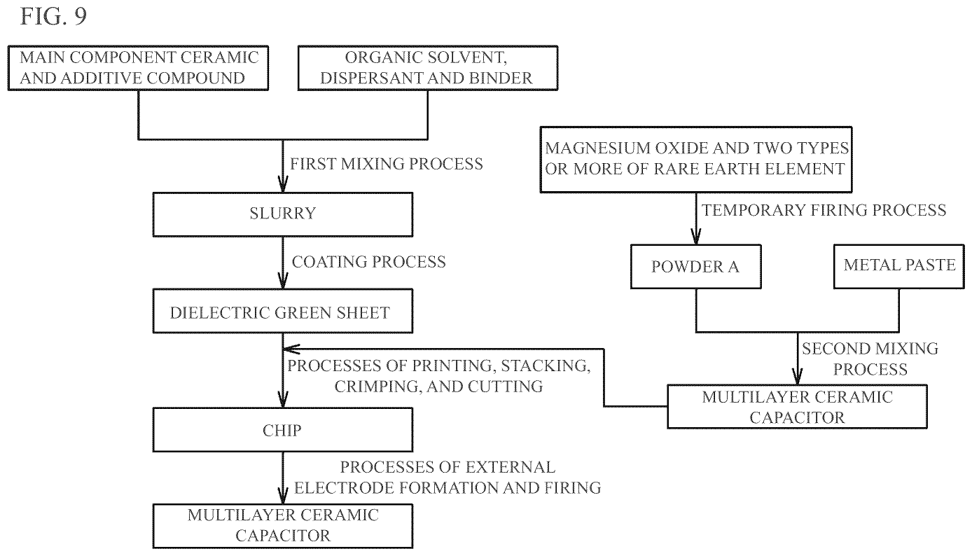

Next, a description will be given of a manufacturing method of the multilayer ceramic capacitors 100. FIG. 9 illustrates a manufacturing method of the multilayer ceramic capacitor 100.

(First mixing process) In a first mixing process, a dielectric material of the main component ceramic of the dielectric layer 11 is prepared. An A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate.

A predetermined additive compound is added to the obtained dielectric powder according to the purpose. As additives to the dielectric layer 11, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon.

For example, the raw material powder and the additive compound are wet mixed, dried, and pulverized to prepare the dielectric material. For example, the raw material powder obtained as described above may be pulverized as necessary to adjust the particle size, or may be combined with a classification process to adjust the particle size. Through the above steps, a dielectric material is obtained.

Next, the obtained dielectric material is wet-mixed with an organic solvent such as ethanol or toluene, a dispersant, and a binder such as polyvinyl butyral (PVB) resin, thereby obtaining a slurry.

(Coating process) The resulting slurry is used to coat a dielectric green sheet 51 onto a base material, for example, using a die coater or doctor blade method, and then dried. The base material is, for example, a polyethylene terephthalate (PET) film.

(Temporary firing process) On the other hand, the oxides of the first rare earth element, the oxides of the second rare earth element, and magnesium oxide are mixed in a mortar or the like and calcined in the atmosphere at a temperature range of from 900° C. or more and 1000° C. or less. This will give powder A. The powder A is to be the segregated material 40 in the firing process described below.

(Second mixing process) The powder A is mixed with a metal paste of the main component metal of the internal electrode layer 12. This results in a metal paste containing the powder A.

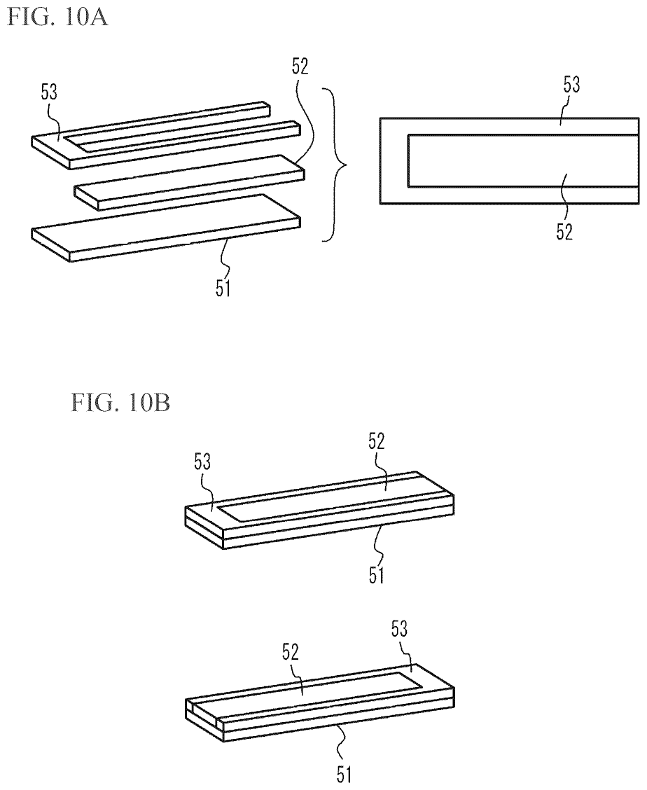

(Printing process) Next, as illustrated in FIG. 10A, the above-mentioned powder A-containing metal paste containing an organic binder is printed on the surface of the dielectric green sheet 51 by screen printing, gravure printing, or the like, to arrange an internal electrode pattern 52 that is alternately drawn out to a pair of external electrodes of different polarities. Ceramic particles may be added to the powder A-containing metal paste as a co-material. The main component of the ceramic particles is not limited. However, it is preferable that the main component of the ceramic particles is the same as the main component of the dielectric layer 11. For example, barium calcium titanate having an average particle size of 50 nm or less may be uniformly dispersed.

Next, a binder such as an ethyl cellulose-based binder and an organic solvent such as a terpineol-based binder are added to the dielectric ceramic composition obtained in the raw material powder making process, and the mixture is kneaded in a roll mill to obtain a dielectric pattern paste for the reverse pattern layer. As illustrated in FIG. 10A, a dielectric pattern 53 is formed by printing the resulting slurry in the peripheral region, where the internal electrode pattern 52 is not printed, on the dielectric green sheet 51 to cause the dielectric pattern 53 and the internal electrode pattern 52 to form a flat surface. The dielectric pattern paste may be made of the same material as the dielectric green sheet 51, or may be made of a material in which an additive compound added to the main component ceramic is different. The dielectric green sheet 51 on which the internal electrode pattern 52 and the dielectric pattern 53 are printed is referred to as a stack unit.

(Stacking process) Thereafter, as illustrated in FIG. 10B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 100 to 1000.

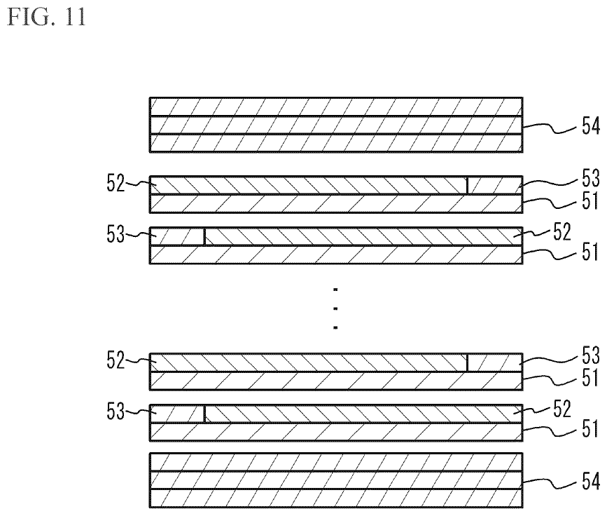

(Crimping process) As illustrated in FIG. 11, a predetermined number (for example, 2 to 10) cover sheets 54 are stacked on the stacked stack units and under the stacked stack units. After that, the stacked structure is thermally crimped. As an example of the ceramic material of the cover sheet 54, the above-mentioned dielectric ceramic composition can be used.

(Cutting process) After that, the chip is cut to a specified chip size (for example, 1.0 mm×0.5 mm) to obtain a chip.

(Forming process of external electrode) The obtained pre-fired chip is subjected to a binder removal process in an N₂ atmosphere, an air atmosphere, or the like, and then a metal paste that will become the base layer of the external electrodes 20a, 20b is applied thereto by a dipping method.

(Firing process) A firing is performed for 5 minutes to 10 hours in a reducing atmosphere with an oxygen partial pressure of 10⁻¹⁰ to 10⁻⁷ atm in a temperature of 1100° C. to 1300° C. Thus, the multilayer ceramic capacitor 100 is obtained.

Furthermore, a re-oxidation process may be performed afterwards in an N₂ gas atmosphere at 600° C. to 1000° C. Furthermore, after that, a metal coating such as Cu, Ni, or Sn may be applied by plating to the base layer of the external electrodes 20a, 20b.

According to the manufacturing method according to this embodiment, when the powder A is preliminarily calcined, the first rare earth element, the second rare earth element, and magnesium become undispersed and segregated. This allows the segregated material 40 to be segregated in the dielectric layer 11 during the firing step. Furthermore, by placing the powder A in the internal electrode pattern 52 instead of the dielectric green sheet 51, it is possible to prevent the first rare earth element, the second rare earth element, and magnesium from being solidly dissolved in the main component ceramic of the dielectric layer 11 during the firing process, and the segregated material 40 is more likely to be located at the interface with the internal electrode layer 12 than in the inner part of the dielectric layer 11.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### Example

The multilayer ceramic capacitors according to the above embodiment were fabricated and their characteristics were examined.

(Comparative Examples 1-3) Barium titanate with an average particle size of about 250 nm was weighed as the main raw material, and various additives, aluminum oxide (Al₂O₃), rare earth elements, organic solvents, and binders were mixed and dispersed in a specified ratio to obtain a slurry. Al₂O₃ was not added in Comparative Example 1, but in Comparative Example 2, 0.2 mol % was added to barium titanate, and in Comparative Example 3, 0.5 mol % was added to barium titanate. The resulting slurry was coated with a 4.0 μm thick dielectric green sheet by a doctor blade method and dried. Ni paste was screen printed on the dielectric green sheet as an internal electrode pattern. To fill in the step between the dielectric green sheet and the internal electrode pattern, a dielectric pattern having a pattern complementary to the internal electrode pattern was screen printed on the dielectric green sheet. After that, 10 layers were stacked, crimped and cut. This gave a MLCC body having a length of 1.0 mm, width of 0.5 mm, and height of 0.5 mm. Ni paste for the external electrode was applied to both end faces on which the internal electrode pattern was exposed.

(Example 1) Barium titanate with an average particle size of about 250 nm was weighed as the main raw material, and various additives, Al₂O₃, rare earth elements, organic solvents and binder were mixed and dispersed in a specified ratio to obtain a slurry. For Al₂O₃, 0.5 mol % was added to barium titanate. The resulting slurry was coated with a 4.0 μm thick dielectric green sheet by a doctor blade method and dried. Separately, holmium oxide (Ho₂O₃), gadolinium oxide (Gd₂O₃), and magnesium oxide (MgO) were mixed in a mortar in a specified ratio, calcined at 900° C. to 1000° C. for 1 hour, and the calcined powder A was disintegrated using a pin mill for 10 hours. Holmium was used as the first rare earth element, and gadolinium was used as the second rare earth element. The crushed powder A was mixed with the Ni paste. The powder A was added to 5 mol % with respect to Ni. The Ni paste was screen printed on the dielectric green sheet as an internal electrode pattern. To fill in the step between the dielectric green sheet and the internal electrode pattern, a dielectric pattern having a pattern complementary to the internal electrode pattern was screen printed on the dielectric green sheet. After that, 10 layers were stacked, crimped and cut. This gave a MLCC body having a length of 1.0 mm, width of 0.5 mm, and height of 0.5 mm. Ni paste for the external electrode was applied to both end faces on which the internal electrode pattern was exposed.

Samples of the MLCC bodies of Comparative Examples 1 to 3 and Example 1 were de-bindered in an N₂ atmosphere at a temperature of 300° C. Thereafter, the MLCC bodies were held at the highest temperature within the temperature range of 1150° C. to 1250° C. for 1 hour and then fired. The temperature rise rate was performed at a slow temperature rise of 400° C./h. The atmosphere here was a highly reduced atmosphere with an oxygen partial pressure of 10⁻⁹ atm or higher. After the temperature was reduced, the temperature was raised to a temperature range of 800° C. to 1050° C. in an N₂ atmosphere, and the temperature was maintained and the re-oxidation process was carried out.

When the cross-section of the dielectric layer was confirmed, in Example 1, a segregated material containing holmium, gadolinium, and magnesium (hereinafter referred to as Ho—Gd—Mg segregated material) was confirmed. This is thought to be because holmium oxide, gadolinium oxide, and magnesium oxide were calcined and mixed with the Ni paste. Many of the confirmed Ho—Gd—Mg segregated materials were located at the interface between the dielectric layer and the internal electrode layer. In Example 1, the average grain size of the Ho—Gd—Mg segregated material was 0.2 μm in the cross section of the dielectric layer. Furthermore, in Example 1, the number of Ho—Gd—Mg segregated materials was 0.04/μm² in the cross section of the dielectric layer. In Comparative Examples 1 to 3, no Ho—Gd—Mg segregated material was confirmed.

In the cross section of the dielectric layer, the average grain size of the dielectric grains was 330 nm in Example 1, 400 nm in Comparative Example 1, 440 nm in Comparative Example 2, and 500 nm in Comparative Example 3.

The number of grain boundary phases with a thickness of 10 nm to 150 nm and containing silicon, aluminum, manganese and vanadium was 0.01/μm² in Example 1, 0 in Comparative Example 1, 0.001 in Comparative Example 2, and 0.02/μm² in Comparative Example 3.

(Whether or not delamination is present) The samples of Example 1 and Comparative Examples 1 to 3 were examined to determine whether delamination occurred. In Comparative Examples 1 to 3, delamination was confirmed. In contrast, in Example 1, no delamination was confirmed. This is thought to be because in Example 1, the Ho—Gd—Mg segregated material was segregated in the dielectric layer, improving the bondability between the dielectric layer and the internal electrode layer.

(Dielectric constant) The samples of Example 1 and Comparative Examples 1 to 3 were heat-reduced (treated at 150° C. for 1 hour), and after 24 hours, the electrostatic capacity was measured using an LCR meter under conditions of 1 kHz and 0.5 Vrms, and the dielectric constant was calculated from the electrostatic capacity. Those with a dielectric constant of 2000 or more and 3500 or less are judged as good “o”, while those with other items are judged as bad “x”. In Comparative Example 3, the dielectric constant was judged as bad “x”. This is thought to be because the average grain size of the dielectric grains has increased.

(Temperature characteristics) After the samples of Example 1 and Comparative Examples 1 to 3 were heated back (treated at 150° C. for 1 hour), the temperature was shifted to −55° C. to 150° C. after 24 hours, and the rate of change in the electrostatic capacity at each temperature when the temperature was set at 25° C. was measured. At this time, the measurement was made at 1 kHz and 0.5 Vrms. The temperature characteristics satisfying X7S (at −55° C. to 125° C., with an electrostatic capacity change rate of ±22%) were judged as good “o”; and the temperature characteristics below X7T (at −55° C. to 125° C., an electrostatic capacity change rate of +22%/−33%) were judged as bad “x”. Note that X7R has an electrostatic capacity change rate of ±15% between −55° C. and 125° C.), which is better than X7S.

The temperature characteristics of Comparative Examples 1 and 2 were X7T. This is thought to be because the grains have grown, and the additives have progressed in solid dissolution, and a large size core of barium titanate could not be secured. The temperature characteristics of Comparative Example 3 were not met either of X7T. This is thought to be because the grains grew largely due to the large amount of aluminum, which deteriorated the temperature characteristics. In contrast, the temperature characteristic of Example 1 was X7S. This is thought to be because even if there was a large amount of aluminum, the presence of Ho—Gd—Mg segregated material prevented grain growth and ensured a large size core of barium titanate.

(Reliability) Samples of Example 1 and Comparative Examples 1 to 3 were subjected to HALT (high-acceleration life test) under conditions of 150° C. and 50 V/μm. The measurement number was 10, and the failure was made when the current value exceeded 1000 μA, and the average time at that time was the HALT life. Those with a HALT lifespan exceeding 5000 min were judged as good “o”, and those with a non-existence lifespan were judged as bad “x”.

In Comparative Example 1, the HALT lifetime was 450 min. This is thought to be because the grain boundaries were thin and the grain boundary resistance was reduced, and the grains grew without the presence of Ho—Gd—Mg segregated material, resulting in a small number of grain boundaries. In Comparative Example 2, the HALT lifetime was 1100 min. The addition of aluminum made the grain boundaries thicker, and it is believed that the lifespan was higher than in Comparative Example 1. In Comparative Example 3, the HALT lifetime was 3500 min. The addition of aluminum made the grain boundaries thicker, and it is thought that the lifespan was higher than that of Comparative Example 2. In contrast, in Example 1, the HALT lifetime was 5800 min. It is believed that due to the sufficient addition of aluminum, the number of areas where grain boundaries have become thick enough, resulting in a longer life.

The above results are shown in Table 2.

TABLE 2

| | SEGREGATED MATERIAL | | | AVERAGE | NUMBER OF | | | | |
|---|---|---|---|---|---|---|---|---|---|
| | | AVERAGE | | GRAIN SIZE OF | GRAIN | | | TEMPER- | |
| | PRESENT | GRAIN | NUM- | DIELECTRIC | BOUNDARY | | | ATURE | |
| | OR | SIZE | BER | GRAIN | (Si + Al + Mn + V) | DELAMI- | DIELECTRIC | CHARAC- | RELI- |
| | ABSENT | (μm) | (/μm²) | (nm) | (/μm²) | NATION | CONSTANT | TERISTIC | ABILITY |
| EXAMPLE 1 | PRESENT | 0.2 | 0.04 | 330 | 0.01 | ABSENT | ∘ | ∘ | ∘ |
| COMPARATIVE | ABSENT | 0 | 0 | 400 | 0 | PRESENT | ∘ | x | x |
| EXAMPLE 1 | | | | | | | | | |
| COMPARATIVE | ABSENT | 0 | 0 | 440 | 0.001 | PRESNET | ∘ | x | x |
| EXAMPLE 2 | | | | | | | | | |
| COMPARATIVE | ABSENT | 0 | 0 | 500 | 0.02 | PRESENT | x | x | x |
| EXAMPLE 3 | | | | | | | | | |

(Example 2) In Example 2, the molar ratio of holmium to magnesium, Ra/Mg, the molar ratio of gadolinium to magnesium, Rb/Mg, and the molar ratio of holmium to gadolinium, Ra/Rb, were varied compared to Example 1. The other conditions were the same as in Example 1. The molar ratio Ra/Mg was 11.3 in Example 1 and 11.3 in Example 2. The molar ratio Rb/Mg was 1.7 in Example 1 and 0.3 in Example 2. The molar ratio Ra/Rb was 6.6 in Example 1 and 37.7 in Example 2.

Similar to Example 1, the presence or absence of delamination, dielectric constant, temperature characteristics, and reliability were also investigated for Example 2. The results are shown in Table 3. In Example 2, grain growth was suppressed more than in Example 1. This is thought to be because the amount of gadolinium was small.

TABLE 3

| | | | | AVERAGE | | | | |
|---|---|---|---|---|---|---|---|---|
| | | | | GRAIN SIZE OF | | | | |
| | | | | DIELECTRIC | | DIELECTRIC | | TEMPERATURE |
| | Ra/Mg | Rb/Mg | Ra/Rb | GRAINS (nm) | DELAMINATION | CONSTANT | RELIABILITY | PROPERTY |
| EXAMPLE 1 | 11.3 | 1.7 | 6.6 | 330 | NONE | ∘ | ∘ | ∘ |
| EXAMPLE 2 | 11.3 | 0.3 | 37.7 | 300 | NONE | ∘ | x | ∘ |

In Example 2, as in Example 1, no delamination occurred. This is thought to be because in Example 1, the Ho—Gd—Mg segregated material was segregated in the dielectric layer, improving the bondability between the dielectric layer and the internal electrode layer.

In Example 2, the dielectric constant was judged as good “o” in the same way as in Example 1. This is thought to be because the average grain size of the dielectric grains was about the same as in Example 1.

The temperature characteristics of Example 2 were X7S, with slightly removed from X7R. This is thought to be because the amount of gadolinium was smaller than that of Example 1, which suppressed grain growth than Example 1, and a large size core of barium titanate was able to be secured.

The HALT lifetime in Example 2 was 4100 min. This is thought to be because the amount of gadolinium was smaller than that of Example 1, and therefore the entropy effect was not obtained as in Example 1.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
a dielectric layer including a main phase and a segregated material containing a first rare earth element, a second rare earth element and magnesium;
a plurality of internal electrode layers sandwiching the dielectric layer; and
external electrodes electrically connected to the plurality of internal electrode layers respectively.

2. The multilayer ceramic electronic device as claimed in claim 1,
wherein the segregated material is in contact with one of the plurality of internal electrode layers.

3. The multilayer ceramic electronic device as claimed in claim 1,
wherein the second rare earth element has a larger ionic radius than the first rare earth element.

4. The multilayer ceramic electronic device as claimed in claim 1,
wherein the first rare earth element is holmium or yttrium, and
wherein the second rare earth element is gadolinium or europium.

5. The multilayer ceramic electronic device as claimed in claim 1,
wherein, in the segregated material, a molar ratio of the first rare earth element to magnesium is 1.5 or more and 50 or less, and a molar ratio of the second rare earth element to magnesium is 0.3 or more and 10 or less.

6. The multilayer ceramic electronic device as claimed in claim 1,
wherein, in the segregated material, a molar ratio of the first rare earth element to the second rare earth element is 1 or more and 16 or less.

7. The multilayer ceramic electronic device as claimed in claim 1,
wherein an average grain size of the segregated material is 0.1 μm or more and 2.0 μm or less.

8. The multilayer ceramic electronic device as claimed in claim 1,
wherein, in a cross section of the dielectric layer, a number of the segregated material is 0.01/μm² or more and 1/μm² or less on average.

9. The multilayer ceramic electronic device as claimed in claim 1,
wherein the main phase has a grain boundary phase, and
wherein the grain boundary phase includes silicon, aluminum, manganese and vanadium.

10. The multilayer ceramic electronic device as claimed in claim 9,
wherein a thickness of the grain boundary phase is 10 nm or more and 150 nm or less, and
wherein a number of the grain boundary phase is 0.01/μm² or more and 1/μm² or less on average in a cross section of the dielectric layer.
